(19) United States
(12) Patent Application Publication
(10) Pub. No.: US 2023/0253135 A1
(43) Pub. Date: Aug. 10, 2023

(54) MAGNETORHEOLOGICAL FLUID AND MANUFACTURING METHOD THEREOF

(71) Applicant: CK MATERIALS LAB CO., LTD., Seoul (KR)

(72) Inventors: Hyeong Jun KIM, Seoul (KR); Yoon Koo KIM, Seoul (KR); Jeong Hoon KIM, Seoul (KR); Woun Ho CHOI, Seoul (KR)

(21) Appl. No.: 17/251,818

(22) PCT Filed: Nov. 6, 2020
(86) PCT No.: PCT/KR2020/015488

§ 371 Date: Dec. 14, 2020

(30) Foreign Application Priority Data
Oct. 30, 2020 (KR) 10-2020-0143043

(51) Int. Cl. H01F 1/44; H01F 41/00

(52) U.S. Cl. CPC H01F 1/447; H01F 41/00

(57) ABSTRACT

The present invention relates to a magnetorheological fluid and a manufacturing method thereof. The magnetorheological fluid according to the present invention includes: a dispersion medium; magnetic particles; and a thixotropic agent, in which the magnetorheological fluid has viscoelasticity, and when shear stress τ of the viscoelasticity of the magnetorheological fluid is τ = τ₀sin(wt) and shear strain γ is γ = γ₀sin(wt + δ) = G′sin(wt) + G″cos [G′ is referred to storage modulus and G″ is referred to as loss modulus], when a magnetic field is applied, the slope of G″ is equal to or less than 0 for the range from 0.01% shear strain applied to the magnetorheological fluid to the shear strain value satisfying tan δ = G″ / G′= 1.

### TECHNICAL FIELD

The present invention relates to a magnetorheological fluid and a manufacturing method thereof. More particularly, the present invention relates to a magnetorheological fluid which includes a dispersion medium, a magnetic particle, and a thixotropic agent and includes a predetermined viscoelastic property to have enhanced dispersion stability and sedimentation stability, and a manufacturing method thereof.

### BACKGROUND OF THE INVENTION

A magnetorheological fluid (MRF), as a suspension in which micro-sized micro magnetic particles sensitive to a magnetic field are mixed in a dispersion medium such as oil or water, is one of smart materials of which flow characteristics can be controlled in real time by application of an external magnetic field.

The magnetorheological fluid exhibits a magnetorheological phenomenon in which a rheological behavior and electrical, thermal, and mechanical properties are changed according to the external magnetic field. In general, the magnetorheological fluid has a Newtonian fluid property when the external magnetic field is not applied, but has a property of a Bingham fluid which has a shear force which hinders a flow of a fluid or a resistance to the flow by forming a chain structure in a direction parallel to a magnetic field to which the magnetic particle is applied therein and generates a constant yield stress without a shear strain when the external magnetic field is applied.

Since the magnetorheological fluid has the resistance to the flow, a rapid response speed, and a reversible characteristic, there is a high applicability to various industrial fields such as a vibration control device such as a damper, a clutch of a vehicle, a brake, etc.

In order for the magnetorheological fluid to be effectively utilized, the magnetorheological fluid should have a high yield stress, and the viscosity of the fluid must be sufficiently low so that the magnetorheological fluid can be quickly restored to an original state thereof when the magnetic field is removed again after the magnetic field is applied, and the magnetic particles inside the magnetorheological fluid should be evenly distributed in the dispersion medium.

However, since the density of the magnetic particles constituting the magnetorheological fluid (for example, tap density of iron particles of 3.9 to 4.1 g/cm3) is still larger than the density (for example, in the case of silicone oil, approximately 0.8 to 1.0/cm3 at room temperature) of the dispersion medium, the magnetic particles are sedimented by gravity in the dispersion medium, thereby reducing the dispersion stability of the magnetorheological fluid. Therefore, when the user uses the magnetorheological fluid, the user suffers from inconvenience that the magnetic particles and the dispersion medium sedimented and separated in a container should be remixed or redispersed, and the physical properties of the magnetorheological fluid may be changed during the remixing/redispersing process.

In order to solve the problem, in the case of Korean Patent Application No. 2000-0025029, the dispersion stability was improved by the interaction with water droplets in the emulsion by adsorbing a water-affinity surfactant on the surface of magnetic particles, but this is difficult to maintain stability for a long time. In addition, in the case of U.S. Pat. No. 5645752, a thixotropic network was formed using colloidal silica and silicon oligomer to achieve the dispersion stability, but there was a problem in that redispersion was difficult due to agglomeration of particles during long-term storage.

On the other hand, in the prior art, the dispersion stability is attempted to be improved by further mixing or reacting a specific substance with a magnetorheological fluid, but there is no definite standard for improving dispersion or sedimentation stability, so that research thereon is required.

### DISCLOSURE OF THE INVENTION

### Technical Problem

Accordingly, the present invention is contrived to solve the problems in the related art and the present invention has been made in an effort to provide a magnetorheological fluid and a manufacturing method thereof which can improve the degree of sedimentation of magnetic particles in a dispersion medium.

The present invention has been made in an effort to provide a magnetorheological fluid and a manufacturing method thereof which present physical property criteria that can improve dispersion stability and sedimentation stability.

The present invention has been made in an effort to provide a magnetorheological fluid having enhanced dispersion stability and sedimentation stability and having a high yield stress, and a manufacturing method thereof.

However, such a problem is exemplary and the scope of the present invention is not limited thereto.

### Technical Solution

An object of the present invention is achieved by a magnetorheological fluid including: a dispersion medium; magnetic particles; and a thixotropic agent, in which the magnetorheological fluid has viscoelasticity, and when shear stress τ of the viscoelasticity of the magnetorheological fluid is τ = τ0sin(wt) and shear strain γ is γ = γ0sin(wt + δ) = G′sin(wt) + G″cos [G′ is referred to storage modulus and G″ is referred to as loss modulus], when a magnetic field is not applied, the slope of G″ is equal to or less than 0 for the range from 0.01% shear strain applied to the magnetorheological fluid to the shear strain value satisfying tan δ = G″ / G′= 1.

According to an embodiment of the present invention, as the content of the thixotropic agents increases, the shear strain value satisfying tan δ = G″ / G′= 1 may increase.

According to an embodiment of the present invention, as the content of the magnetic particles increases, formation of a three-dimensional network by the thixotropic agent is weakened and the shear strain value satisfying tan δ = G″ / G′= 1 may decrease.

According to an embodiment of the present invention, as the content of the thixotropic agent increases, the three-dimensional network by the thixotropic agent is strengthened and the viscosity of the magnetorheological fluid may increase.

According to an embodiment of the present invention, when the magnetic field is not applied, G′ may be at least greater than 250 Pa in an initial linear region and G″ may be at least greater than 75 Pa in the initial linear region.

According to an embodiment of the present invention, when the magnetic field is not applied, a flow point (τf) value may be at least greater than 10 Pa.

According to an embodiment of the present invention, when the magnetic field is applied, for the section from 0.01% shear strain applied to the magnetorheological fluid to the shear strain value that satisfies tan δ = G″ / G′= 1, before the values of G′ and G″ become equal to each other, the section may include at least one portion in which the slope of G″ changes from positive to negative.

According to an embodiment of the present invention, as the intensity of the applied magnetic field increases, the shear strain value corresponding to the portion where the slope of G″ changes from positive to negative may increase before the G′ and G″ values become equal to each other.

According to an embodiment of the present invention, as the content of magnetic particles increases, an integral value of G″ may increase for a section in which the value of shear strain applied to the magnetorheological fluid is in the range of 0.01% to 100%.

According to an embodiment of the present invention, as the intensity of the applied magnetic field increases, the integral value of G″ may increase for the section in which the value of shear strain applied to the magnetorheological fluid is in the range of 0.01% to 100%.

According to an embodiment of the present invention, the applied magnetic field intensity and the bump area have a linear relationship y = ax + b [x represents the magnetic field intensity, y represents the bump area], and a = 73.1 ± 2.0.

According to an embodiment of the present invention, when the shear strain value satisfying tan δ = G″ / G′= 1 is 15% or more and 35% or less, the sedimentation rate S is at least greater than 80%, and a sedimentation rate S is measured by naturally sedimenting the magnetorheological fluid in a measuring cylinder for 60 days, the sedimentation rate S is at least greater than 80% and S(vol%)=100 - [(ΔS) / (h)] X 100 [ΔS corresponds to the height of a supernatant liquid after a certain time after filling a cylinder with the magnetorheological fluid, and h corresponds to the initial height of the cylinder with the magnetorheological fluid].

According to an embodiment of the present invention, the thixotropic agent may contain at least a silicone or clay component.

Another object of the present invention is achieved by a method for manufacturing a magnetorheological fluid, including a dispersion medium; magnetic particles; and a thixotropic agent, in which the magnetorheological fluid has viscoelasticity, and when shear stress τ of the viscoelasticity of the magnetorheological fluid is τ = τ0sin(wt) and shear strain γ is γ = γ0sin(wt + δ) = G′sin(wt) + G″cos [G′ is referred to storage modulus and G″ is referred to as loss modulus], when a magnetic field is not applied, the slope of G″ is equal to or less than 0 for the range from 0.01% shear strain applied to the magnetorheological fluid to the shear strain value satisfying tan δ = G″ / G′= 1.

According to an embodiment of the present invention, as the content of the thixotropic agents increases, the shear strain value satisfying tan δ = G″ / G′= 1 may increase.

According to an embodiment of the present invention, as the content of the magnetic particles increases, formation of a three-dimensional network by the thixotropic agent is weakened and the shear strain value satisfying tan δ = G″ / G′= 1 may decrease.

According to an embodiment of the present invention, as the content of the thixotropic agent increases, the three-dimensional network by the thixotropic agent is strengthened and the viscosity of the magnetorheological fluid may increase.

According to an embodiment of the present invention, when the magnetic field is applied, for the section from 0.01% shear strain applied to the magnetorheological fluid to the shear strain value that satisfies tan δ = G″ / G′= 1, before the values of G′ and G″ become equal to each other, the section may include at least one portion in which the slope of G″ changes from positive to negative.

According to an embodiment of the present invention, as the intensity of the applied magnetic field increases, the shear strain value corresponding to the portion where the slope of G″ changes from positive to negative may increase before the G′ and G″ values become equal to each other.

According to an embodiment of the present invention, as the content of magnetic particles increases, the integral value of G″ may increase for the section in which the value of shear strain applied to the magnetorheological fluid is in the range of 0.01% to 100%.

According to an embodiment of the present invention, as the intensity of the applied magnetic field increases, the integral value of G″ may increase for the section in which the value of shear strain applied to the magnetorheological fluid is in the range of 0.01% to 100%.

According to an embodiment of the present invention, the applied magnetic field intensity and the bump area have a linear relationship y = ax + b [x represents the magnetic field intensity, y represents the bump area], and a = 73.1 ± 2.0.

### Advantageous Effects

According to the present invention configured as described above, there is an effect of improving the degree of sedimentation of magnetic particles in the dispersion medium of the magnetorheological fluid.

According to the present invention, there is an effect of presenting a physical property standard that can improve the dispersion stability and sedimentation stability of the magnetorheological fluid.

According to the present invention, there is an effect that the magnetorheological fluid has a high yield stress while improving the dispersion stability and the sedimentation stability.

Of course, the scope of the present invention is not limited by such an effect.

### BRIEF DESCRIPTION OF THE DRAWINGS

FIGS. 1A to 1C are graphs showing a storage modulus and a loss modulus of a magnetorheological fluid having viscoelastic properties according to an embodiment of the present invention (see https://wiki.anton-paar.com/kr-en/amplitude-sweeps/).

FIGS. 2A to 2C are schematic diagrams showing the behavior of a thixotropic agent in a magnetorheological fluid according to an embodiment of the present invention (see J. Non-Newtonian Fluid Mech., 70 (1997) 1-33).

FIG. 3 is a schematic diagram showing sedimentation rate measurement of a magnetorheological fluid according to an embodiment of the present invention.

FIG. 4 is a graph showing crosspoint-viscosity of samples according to an embodiment of the present invention.

FIG. 5 is a graph showing a crosspoint-sedimentation rate of samples according to an embodiment of the present invention.

FIG. 6A is a graph showing a storage modulus and a loss modulus when a magnetic field is not applied, and FIG. 6B is a graph showing a storage modulus and a loss modulus when the magnetic field is applied, according to an embodiment of the present invention.

FIGS. 7A and 7B are graphs showing a relationship between a bump area and a shear stress according to an embodiment of the present invention.

FIG. 8 is a graph of simulating a bump plot according to an embodiment of the present invention.

FIG. 9 shows a process of obtaining a bump area according to an embodiment of the present invention.

FIGS. 10A to 10D are graphs showing a storage modulus and a loss modulus according to a magnetic field intensity according to an embodiment of the present invention.

FIG. 11 is a graph showing a bump area according to a magnetic field intensity according to an embodiment of the present invention.

### MODE FOR CARRYING OUT THE INVENTION

The following detailed description of the present invention will be made with reference to the accompanying drawings which illustrate a specified embodiment in which the present invention may be implemented as an example. The embodiment will be described in enough detail so that those skilled in the art are able to embody the present invention. It should be understood that various embodiments of the present invention are different from each other and need not be mutually exclusive. For example, specific shapes, structures, and characteristics described herein may be implemented in other embodiments without departing from the spirit and scope of the present invention in relation to one embodiment. In addition, it is to be understood that the location or arrangement of individual components within each disclosed embodiment may be changed without departing from the spirit and scope of the present invention. Accordingly, the detailed description to be described below is not intended to be taken in a limiting sense, and the scope of the present invention, if properly described, is limited only by the appended claims, along with all scopes equivalent to those claimed by the claims. In the drawings, similar reference numerals refer to the same or similar functions over various aspects, and the length, area, thickness, and the like and the form may be exaggerated for convenience.

In the present specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Hereinafter, preferred embodiments of the present invention will be described in detail with reference to the accompanying drawings so that those skilled in the art may easily implement the present invention.

According to an embodiment of the present invention, a magnetorheological fluid may have a phase in which a liquid phase and a solid phase are converted or the liquid phase and the solid phase are mixed according to an external magnetic field. Magnetic particles included in the magnetorheological fluid may form a chain according to the external magnetic field, and thus exhibit properties similar to solids.

According to an embodiment of the present invention, the magnetorheological fluid may include a mixture of a dispersion medium, magnetic particles, and a thixotropic agent.

The dispersion medium is a material that allows a magnetic powder composite to be dispersed to form a suspension, and has a polar or non-polar property, and a low viscosity is preferable for a maximum magnetorheological effect.

For example, the dispersion medium may be at least one selected from the group consisting of silicone oil, mineral oil, paraffin oil, corn oil, hydrocarbon oil, castor oil, and vacuum oil. In addition, the dispersion medium may have a kinematic viscosity of 40° C. in the range of approximately 5 to 300 mm2/s. If the kinematic viscosity is lower than the range, there may be a problem of lowering a sedimentation property, and if the kinematic viscosity is higher than the range, there may be a problem of lowering the fluidity, so it is preferable that the kinematic viscosity is included in the range.

The magnetic particles may be at least one selected from iron, carbonyl iron, iron alloy, iron oxide, iron nitride, carbide iron, low carbon steel, nickel, cobalt, and mixtures thereof or alloys thereof. The average particle diameter of the magnetic particles may be approximately 1 to 100 µm. Further, the magnetic particles may be uncoated magnetic particles or magnetic particles coated with an organic resin.

For example, the magnetic particles may be included in an amount of approximately 65 to 85 wt% in the magnetorheological fluid. If the magnetic particles are included in a lower content than the above content, a shear stress may be lowered, and if the magnetic particles are included in a higher content than the above content, a fluidity problem may appear, and as a result, it is preferable that the content is included within the above range.

As the thixotropic agent is mixed and dispersed in the magnetorheological fluid, a known thixotropic agent may be used that causes the magnetorheological fluid to exhibit thixotropy.

Besides, the magnetorheological fluid may further include a dispersing agent, an antifriction agent, an antioxidant, and a corrosion inhibitor as conventional additives.

In the present invention, viscoelasticity is presented as a means for measuring properties similar to solids of the magnetorheological fluid. As for elastic, a shear stress-shear strain curve indicates linearity. The viscoelasticity exhibits hysteresis in the shear stress-shear strain curve, which is due to energy loss when an external force is applied.

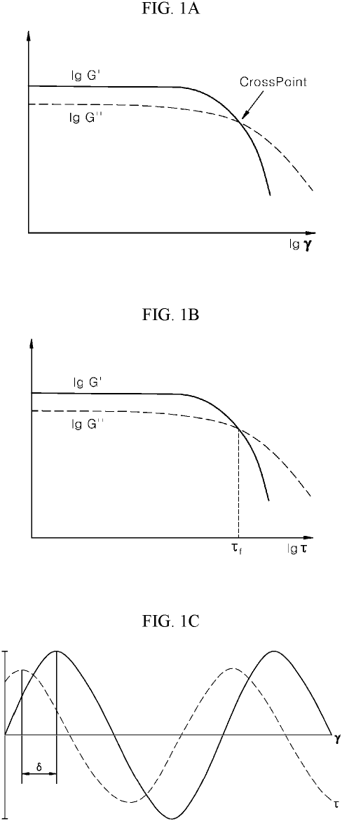

FIGS. 1A and 1C are graphs showing a storage modulus and a loss modulus of a magnetorheological fluid having viscoelastic properties according to an embodiment of the present invention (see https://wiki.anton-paar.com/kr-en/amplitude-sweeps/).

Referring to FIGS. 1A to 1C, the viscoelasticity requires oscillating shear stress τ and shear strain γ, and may be expressed as follows.

$$\text{τ} = \text{τ} 0 sin \left(\text{wt}\right)$$

$$\text{γ} = \text{γ} 0 sin \left(\text{wt+} \text{δ}\right)$$

Here, (i) when δ = 0, the magnetorheological fluid is an elastic material, (ii) when δ = π/2, the magnetorheological fluid is a viscous material, and (iii) when 0 < δ < π/2, the magnetorheological fluid is a viscoelastic material.

$$\begin{matrix}\text{γ} \text{may be represented as} \text{γ} = \text{γ} 0 sin \left(\text{wt+} \text{δ}\right) \\ = \text{γ} 0 \left(sin \left(\text{wt}\right) cos \text{δ} + cos \left(\text{wt}\right) \text{sing} \text{δ}\right) \\ = \text{G′sin} \left(\text{wt}\right) + \text{G″cos} \left(\text{wt}\right) .\end{matrix}$$

Here, G′ is referred to as a storage modulus and G″ is referred to as a loss modulus.

With a linear viscoelastic region test of the magnetorheological fluid, three parameters such as storage modulus G′, loss modulus G″, crosspoint, and flow point τf may be measured. After arranging the magnetorheological fluid on a fixed base, a viscoelasticity test may be performed by a method for measuring torque by rotating the magnetorheological fluid while compressing the magnetorheological fluid from the top with a pressing means. In one embodiment, at a temperature T = 25° C., it is possible to measure G, G″, cross point, and flow point by adjusting the angular velocity ω = 10 rad/s of the compressing means.

Referring to FIG. 1A, the crosspoint corresponds to a shear strain value satisfying tan δ = G″ / G′ = 1. That is, the shear strain value of the boundary point passing tan δ < 1 (a structure in which solid properties dominate) tan δ > 1 (a structure in which fluid properties dominate) corresponds to the crosspoint. Referring to FIG. 1B, the flow point corresponds to a shear strain value satisfying tan δ = G″ / G′ = 1. Further, referring to FIG. 1C, τ = τ0sin(wt) and γ = γ0sin(wt + δ) show a phase difference of δ. In FIGS. 1A and 1B, a region in which initial values of lg G′ and lg G″ do not change may be regarded as a linear region.

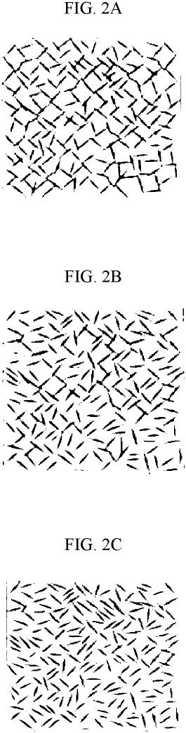

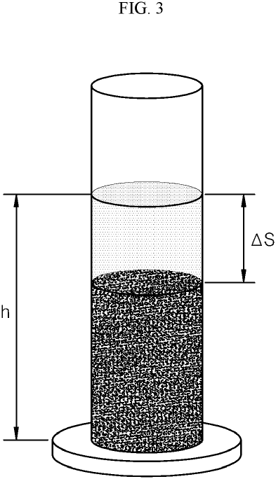

FIGS. 2A and 2C are schematic diagrams showing the behavior of a thixotropic agent in a magnetorheological fluid according to an embodiment of the present invention (see J. Non-Newtonian Fluid Mech., 70 (1997) 1-33).

From FIG. 2A to FIG. 2C, the three-dimensional network structure in the magnetorheological fluid is broken down, and the viscosity of the magnetorheological fluid is lowered, resulting in the viscous material. On the contrary, from FIG. 2C to FIG. 2A, the three-dimensional network structure in the magnetorheological fluid is built up, and the viscosity of the magnetorheological fluid is increased, resulting in the elastic material.

The thixotropic agent may form a three-dimensional network structure within the magnetorheological fluid over time. In FIG. 2C, the change form of FIG. 2A is shown, so that the viscosity increases and the solid properties increase. The three-dimensional network structure of the thixotropic agent may be destroyed when the external force is applied. In another aspect, the value of the crosspoint in the viscoelasticity test of FIGS. 1A to 1C is proportional to the strength of the 3D network.

FIG. 3 is a schematic diagram showing sedimentation measurement of a magnetorheological fluid according to an embodiment of the present invention.

Referring to FIG. 3, a sedimentation rate S may be measured as follows.

$$\text{S} \left(\text{vol\%}\right) = 100 \text{-} \left[\left(\text{Δ} \text{S}\right) / \left(\text{h}\right)\right] \times \text{100}$$

Here, ΔS corresponds to the height of a supernatant liquid after a certain time after filling a cylinder with the magnetorheological fluid, and h corresponds to the initial height of the cylinder filled with the magnetorheological fluid. The supernatant liquid refers to the upper layer layer-separated by the sedimentation of the magnetic particles in the magnetorheological fluid.

For example, the magnetorheological fluid may be filled in a container that is maintained horizontally, and the degree of the sedimentation may be measured at every set time by setting a state in which no sedimentation occurs as 100%.

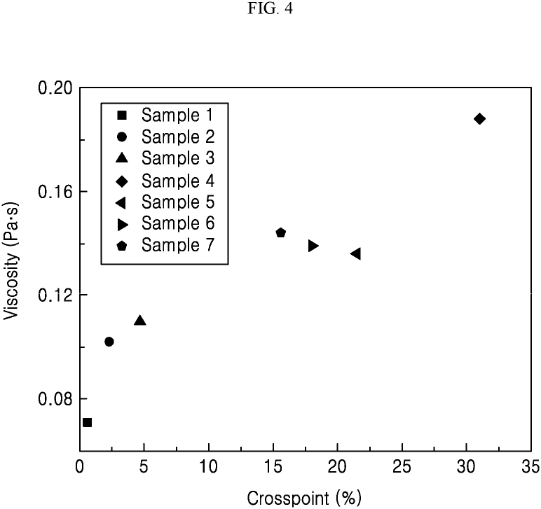

FIG. 4 is a graph showing crosspoint-viscosity of samples according to an embodiment of the present invention. Referring to FIG. 1A, the crosspoint corresponds to a shear strain value satisfying tan δ = G″ / G′ = 1. The viscosity was measured at a magnetic field non-application, a temperature of 25° C., and a shear rate of 1,500/s.

In the present invention, the measurement was performed with 7 types of samples. Samples in which the content of the magnetic particles, the types of thixotropic agent, and the content of the thixotropic agent were changed were prepared. Silicon-based thixotropic agents are typically fumed silica, and clay-based thixotropic agents representatively include Bentonite clay, Smectite clay, Montmorillonite clay, and Hectorite clay, and specific commercial products include claysClaytone AF, Bentone®, Baragel®, and Nykon®.

### Sample 1

A magnetorheological fluid containing 70 to 80 wt% of magnetic particles, 1 to 5 wt% of thixotropic agent 1, and the dispersion medium and an additive as a balance was used. Thixotropic Agent 1 is a thixotropic agent based on a silicone component.

### Sample 2

A magnetorheological fluid was used, which includes magnetic particles in the same content as Sample 1, contains thixotropic agent 2 by 10% less than Sample 1, and contains the dispersion medium and additives as the balance. Thixotropic Agent 2 is an Organophilic Phyllosilicate based thixotropic agent with a clay based density of 1.5 g/ml.

### Sample 3

A magnetorheological fluid was used, which includes magnetic particles in the same content as Sample 1, contains thixotropic agent 2 in the same content as Sample 1, and contains the dispersion medium and additives as the balance.

### Sample 4

A magnetorheological fluid was used, which includes magnetic particles in the same content as Sample 1, contains thixotropic agent 3 by 10% more than Sample 1, and contains the dispersion medium and additives as the balance. Thixotropic agent 3 is a clay-based Bentonite based thixotropic agent.

### Sample 5

A magnetorheological fluid was used, which includes magnetic particles by 5% less than Sample 1, contains thixotropic agent 3 in the same content as Sample 1, and contains the dispersion medium and additives as the balance.

### Sample 6

A magnetorheological fluid was used, which includes magnetic particles in the same content as Sample 1, contains thixotropic agent 3 in the same content as Sample 1, and contains the dispersion medium and additives as the balance.

### Sample 7

A magnetorheological fluid was used, which includes magnetic particles by 5% more than Sample 1, contains thixotropic agent 3 in the same content as Sample 1, and contains the dispersion medium and additives as the balance.

When the magnetic field of each sample is not applied, the values of G′ and G″ in the initial linear region when the magnetic field is applied, the crosspoint, and the flow point (τf) values are respectively shown in the table below.

TABLE 1

| When magnetic field is not applied | G′(Pa) | G″(Pa) | Crosspoint(%) | τ_{f}(Pa) |
|---|---|---|---|---|
| Sample 1 | 80.6 | 44.5 | 0.59 | 0.29 |
| Sample 2 | 235.2 | 89.0 | 2.29 | 2.95 |
| Sample 3 | 215.9 | 66.6 | 4.68 | 3.77 |
| Sample 4 | 271.6 | 78.2 | 31.02 | 11.16 |
| Sample 5 | 297.5 | 86.1 | 21.49 | 11.45 |
| Sample 6 | 324.8 | 95.13 | 18.02 | 10.40 |
| Sample 7 | 383.5 | 107.3 | 15.59 | 10.08 |

TABLE 2

| When magnetic field is applied (250mT) | G′(kPa) | G″ (kPa) | Crosspoint(%) | τ_{f}(Pa) |
|---|---|---|---|---|
| Sample 4 | 1060.0 | 55.9 | 74.5 | 8.34 |
| Sample 5 | 1025.8 | 58.4 | 74.8 | 8.27 |
| Sample 6 | 1051.2 | 60.7 | 75.3 | 8.38 |
| Sample 7 | 1103.8 | 51.7 | 76.3 | 8.47 |

Referring to FIG. 4, it can be seen that crosspoint and the viscosity gradually increase in the three groups of Samples 1, 2 and 3, and Samples 4 to 7. Eventually, it can be seen that G′ and G″ change according to the types of thixotropic agents 1, 2, and 3, and since G′ and G″ are different, the cross point and the viscosity are different.

It can be seen that when comparing Samples 2 and 3, the crosspoint and the viscosity of Sample 3 are high, and when comparing Samples 4 and 6, the crosspoint and the viscosity of Sample 4 are high. That is, it can be seen that even in the same thixotropic agent, as the content of the thixotropic agent increases, the three-dimensional network in the magnetorheological fluid is strengthened and the crosspoint and the viscosity increase.

In contrast to Samples 5 to 7, it can be seen that the viscosity increases but the crosspoint decreases from Sample 5 to Sample 7. That is, it can be seen that as the content of the magnetic particles increases, the viscosity of the magnetorheological fluid increases due to the increased amount of the magnetic particles, but the increased magnetic particles hinder forming of the 3-dimensional network by the thixotropic agent, and as a result, the degree to which G″ rises is larger than the degree to which G′ rises, thereby eventually reducing the crosspoint.

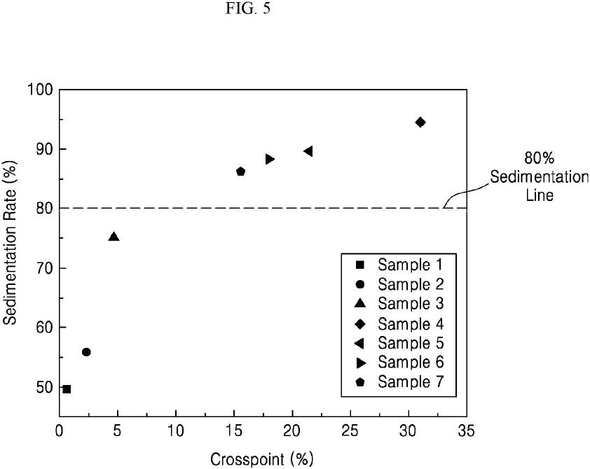

FIG. 5 is a graph showing crosspoint-sedimentation rate of samples according to an embodiment of the present invention.

Referring to FIG. 5, it can be seen that sedimentation is improved as the crosspoint increases for each sample. For example, in order for the magnetorheological fluid to have excellent sedimentation stability and be used in practice, a sedimentation rate of 80% or more may be required when measured after natural sedimentation for 60 days. In FIG. 5, in order to ensure the sedimentation rate of 80% or more, it is preferably considered that the crosspoint of the magnetorheological fluid is at least 15% or more and 35% or less. That is, the magnetorheological fluid of the present invention is characterized in that a shear strain value satisfying tan δ = G″ / G′= 1 is at least 15% or more. In FIG. 5, Samples 4 to 7 satisfy the above condition.

In Samples 4 to 7, it can be seen that when the magnetic field is not applied, G′ appears to be greater than 250 Pa preferably 250 Pa or more and 450 Pa or less, and when the magnetic field is applied, G′ appears to be greater than 1,000 kPa, preferably 1,000 kPa or more and 1,200 kPa or less.

In Samples 4 to 7, it can be seen that when the magnetic field is not applied, the value of the flow point Ó is greater than 10 Pa, preferably 10 Pa or more and 12 Pa or less.

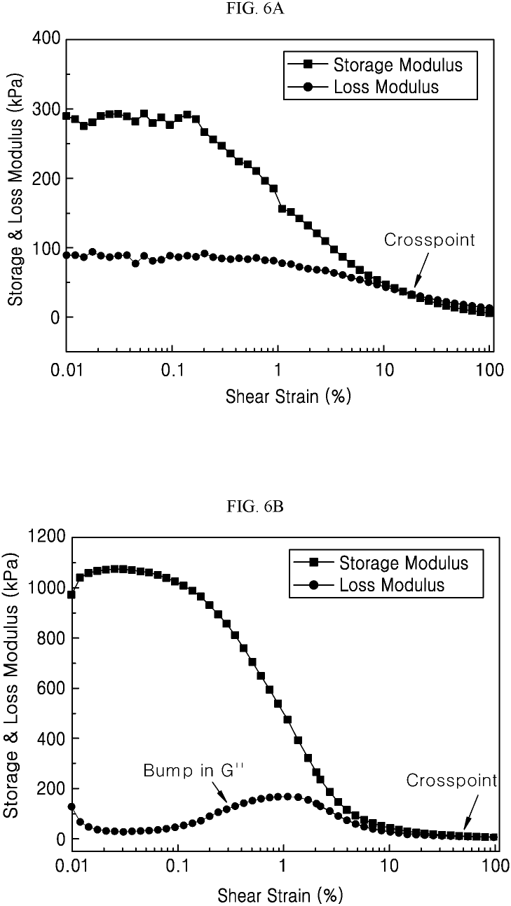

FIG. 6A is a graph showing a storage modulus G′ and a loss modulus G″ when a magnetic field is not applied, and FIG. 6B is a graph showing a storage modulus and a loss modulus when the magnetic field is applied, according to an embodiment of the present invention.

As shown in FIG. 6A, when the magnetic field is not applied, a bump does not appear at the loss modulus G″. Since the slope of G″ is horizontal or has a negative slope, the slope value is equal to or less than 0. For example, for a section ranging from 0.01% shear strain to the crosspoint, a slope value of G″ may be 0 or less.

On the other hand, as shown in FIG. 6B, when the magnetic field is applied, for example, when a magnetic field of 250 mT is applied, the bump appears in the loss modulus G″. The bump is before the G′ and G″ values become equal to each other, in other words, before reaching the crosspoint, the bump may correspond to at least one portion in which the slope of G″ changes from positive to negative. For example, for a section from 0.01% shear strain to the crosspoint, the bump may include at least one portion in which the slope of G″ before the crosspoint changes from positive to negative. When the bump appears, the area of the bump means the force resisting the flow of the magnetorheological fluid, which corresponds to the energy lost by the damping force exerted by the magnetorheological fluid. In this case, a general numerical integration method such as a trapezoidal rule may be used for the integration to obtain the area of the bump.

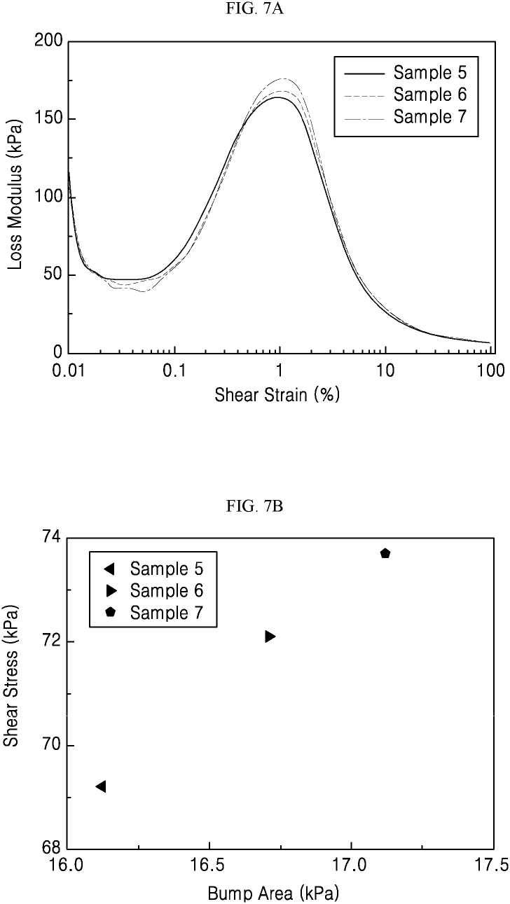

FIGS. 7A and 7B are graphs showing a relationship between a bump area and a shear stress according to an embodiment of the present invention.

FIG. 7A is a diagram showing bump areas for Samples 5 to 7. For example, when a magnetic field of approximately 250 mT is applied, the bump area may be understood as a parameter representing the maximum damping force that the magnetorheological fluid of Samples 5 to 7 may exert, and may be calculated by integrating the loss modulus G″ of FIG. 6B for the shear strain. In the case of integration by expressing the shear strain in %, the loss modulus G″ may be integrated by dividing by 100.

The bump area may correspond to a force that breaks the chain structure of magnetic particles formed when the magnetic field is applied to the magnetorheological fluid.

Referring to FIG. 7B, it can be seen that the bump area gradually increases from Sample 5 to Sample 7, and the shear stress at the shear rate of 1,500/s of the magnetorheological fluid increases when the magnetic field of 570 mT is applied. That is, it can be seen that the larger the content of the magnetic particles, the larger the bump area. This also corresponds to an increase in viscosity from Sample 5 to Sample 7 as shown in FIG. 4.

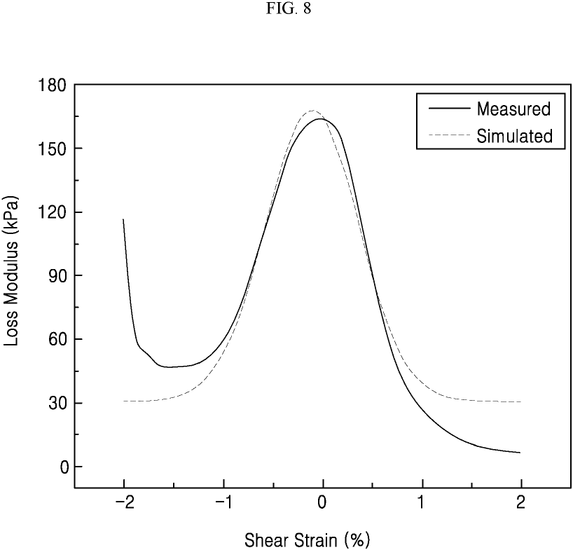

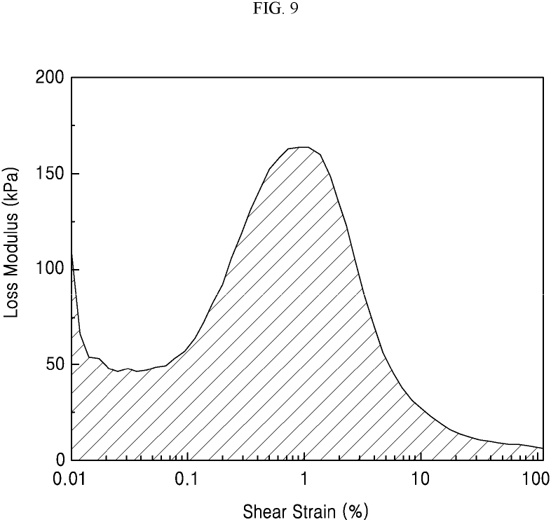

FIG. 8 is a graph of simulating a bump plot according to an embodiment of the present invention. FIG. 9 shows a process of obtaining a bump area according to an embodiment of the present invention.

Referring to FIG. 8, the maximum value of the bump may be derived by simulating the measured loss modulus (G″) plot.

According to an embodiment, the loss modulus (G″) plot may be quantified by the following equation.

$$y = {y}_{0} + \left(\frac{A}{\text{ω} \sqrt{π / 2}}\right) {e}^{\left(- 2 {\left(\frac{x - {x}_{c}}{\text{ω}}\right)}^{2}\right)}$$

However, the method of simulating the plot is not particularly limited to the Gaussian method, and a known method may be used.

Next, referring to FIG. 9, the lower area of the loss modulus (G″) plot may be integrated. An integration value of the lower area of the loss modulus (G″) plot, that is, the bump plot may correspond to the bump area. The bump area is a parameter that may correspond to the maximum damping force that the magnetorheological fluid may exert. The bump area of the magnetorheological fluid of the present invention shown in FIGS. 7 and 9 may be approximately 16 kPa to 17.5 kPa when a magnetic field of approximately 250 mT is applied.

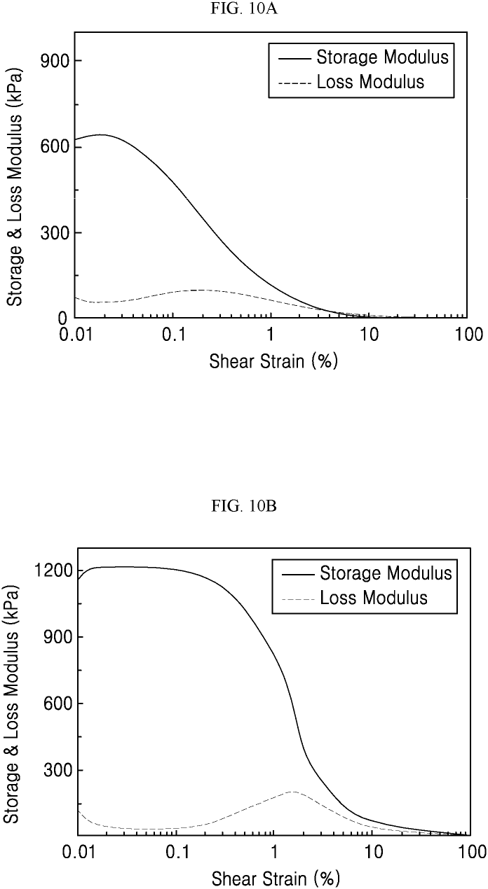

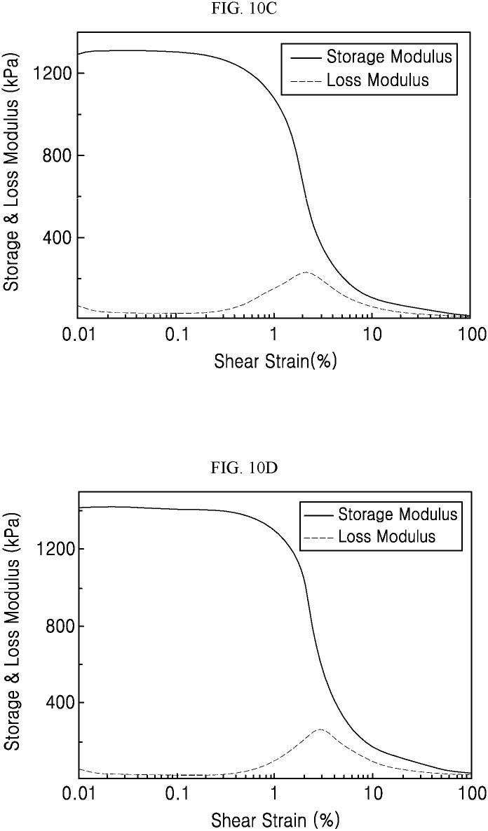

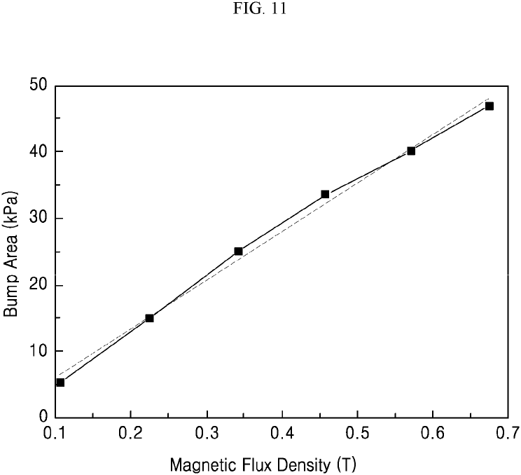

FIGS. 10A to 10D are graphs showing a storage modulus and a loss modulus according to a magnetic field intensity according to an embodiment of the present invention. FIG. 11 is a graph showing a bump area according to a magnetic field intensity according to an embodiment of the present invention.

Referring to FIGS. 10A to 10D, it can be seen that the bump moves to the right as the intensity of the applied magnetic field increases, i.e. 0.106 T (FIG. 10A), 0.343 T (FIG. 10B), 0.458 T (FIG. 10C), and 0.675 T (FIG. 10D). That is, it can be seen that the shear strain value corresponding to the bump increases.

Referring to FIG. 11, it can be seen that the larger the magnetic field intensity is applied, the larger the bump area is. As the intensity of the applied magnetic field increases, the chain structure of more magnetic particles is formed in the magnetorheological fluid, so that a bump area corresponding to a force that breaks the chain structure may increase.

The relationship between the magnetic field intensity and the bump area may be expressed as a linear function (dotted line in FIG. 11). According to an embodiment, when y = ax + b [x represents the magnetic field intensity, y represents the bump area], if a dotted line slope of FIG. 11 is plotted, a may be approximately 73.1 ± 2.0.

As described above, the present invention proposes a physical property standard that can improve the dispersion stability and sedimentation stability of the magnetorheological fluid, and there is an effect of improving the degree of sedimentation of magnetic particles in the dispersion medium of the magnetorheological fluid. In addition, in the magnetorheological fluid according to the present invention, there is an effect that the magnetorheological fluid has a high yield stress while improving the dispersion stability and the sedimentation stability.

Although the present invention has been shown and described with reference to a preferred embodiment as described above, the present invention is not limited to the above embodiment, and within the scope without departing from the spirit of the present invention, various modifications and changes can be made by those skilled in the art. It should be considered that such modification example and change example belong to the scopes of the present invention and the appended claims.

1. A magnetorheological fluid comprising:
a dispersion medium;
magnetic particles; and
a thixotropic agent,
wherein the magnetorheological fluid has viscoelasticity, and
when shear stress τ of the viscoelasticity of the magnetorheological fluid is τ = τ₀sin(wt) and shear strain γ is γ = γ₀sin(wt+δ) = G′sin(wt) + G″cos [G′ is referred to as storage modulus and G″ is referred to as loss modulus],
when a magnetic field is not applied, the slope of G″ is equal to or less than 0 for the range from 0.01% shear strain applied to the magnetorheological fluid to the shear strain value satisfying tan δ = G″ / G′= 1.

2. The magnetorheological fluid of claim 1, wherein as the content of the thixotropic agent increases, the shear strain value satisfying tan δ = G″ / G′= 1 increases.

3. The magnetorheological fluid of claim 1, wherein as the content of the magnetic particles increases, formation of a three-dimensional network by the thixotropic agent is weakened and the shear strain value satisfying tan δ = G″ / G′= 1 decreases.

4. The magnetorheological fluid of claim 1, wherein as the content of the thixotropic agent increases, the three-dimensional network by the thixotropic agent is strengthened and the viscosity of the magnetorheological fluid increases.

5. The magnetorheological fluid of claim 1, wherein when the magnetic field is not applied, G′ is at least greater than 250 Pa and G″ is at least greater than 75 Pa.

6. The magnetorheological fluid of claim 1, wherein when the magnetic field is not applied, a flow point (τ_{f}) value is at least greater than 10 Pa.

7. The magnetorheological fluid of claim 1, wherein when the magnetic field is applied, for the section from 0.01% shear strain applied to the magnetorheological fluid to the shear strain value that satisfies tan δ = G″ / G′= 1, before the values of G′ and G″ become equal to each other, the section includes at least one portion in which the slope of G″ changes from positive to negative.

8. The magnetorheological fluid of claim 7, wherein as the intensity of the applied magnetic field increases, the shear strain value corresponding to the portion where the slope of G″ changes from positive to negative before the G′ and G″ values become equal to each other increases.

9. The magnetorheological fluid of claim 7, wherein as the content of magnetic particles increases, an integral value of G″ increases for a section in which the value of shear strain applied to the magnetorheological fluid is in the range of 0.01% to 100%.

10. The magnetorheological fluid of claim 7, wherein as the intensity of the applied magnetic field increases, the integral value of G″ increases for the section in which the value of shear strain applied to the magnetorheological fluid is in the range of 0.01% to 100%.

11. The magnetorheological fluid of claim 7, wherein the applied magnetic field intensity and the bump area have a linear relationship y = ax + b [x represents the magnetic field intensity, y represents the bump area], and a = 73.1 ± 2.0.

12. The magnetorheological fluid of claim 1, wherein when the shear strain value satisfying tan δ = G″ / G′= 1 is 15% or more and 35% or less, the sedimentation rate S is at least greater than 80%, and
S(vol%)=100 - [(ΔS) / (h)] X 100 [ΔS corresponds to the height of a supernatant liquid after a certain time after filling a cylinder with the magnetorheological fluid, and h corresponds to the initial height of the cylinder with the magnetorheological fluid].

13. The magnetorheological fluid of claim 1, wherein the thixotropic agent contains at least a silicone or clay component.

14. A method for manufacturing a magnetorheological fluid including a dispersion medium, magnetic particles, and a thixotropic agent, wherein the magnetorheological fluid has viscoelasticity,
when shear stress τ of the viscoelasticity of the magnetorheological fluid is τ = τ₀sin(wt) and shear strain γ is γ = γ₀sin(wt + δ) = G′sin(wt) + G″cos [G′ is referred to storage modulus and G″ is referred to as loss modulus],
when a magnetic field is not applied, the slope of G″ is equal to or less than 0 for the range from 0.01% shear strain applied to the magnetorheological fluid to the shear strain value satisfying tan δ = G″ / G′= 1.

15. The method of claim 14, wherein as the content of the thixotropic agent increases, the shear strain value satisfying tan δ = G″ / G′= 1 increases.

16. The method of claim 14, wherein as the content of the magnetic particles increases, formation of a three-dimensional network by the thixotropic agent is weakened and the shear strain value satisfying tan δ = G″ / G′= 1 decreases.

17. The method of claim 14, wherein as the content of the thixotropic agent increases, the three-dimensional network by the thixotropic agent is strengthened and the viscosity of the magnetorheological fluid increases.

18. The method of claim 14, wherein when the magnetic field is applied, for the section from 0.01% shear strain applied to the magnetorheological fluid to the shear strain value that satisfies tan δ = G″ / G′= 1, before the values of G′ and G″ become equal to each other, the section includes at least one portion in which the slope of G″ changes from positive to negative.

19. The method of claim 18, wherein as the intensity of the applied magnetic field increases, the shear strain value corresponding to the portion where the slope of G″ changes from positive to negative before the G′ and G″ values become equal to each other increases.

20. The method of claim 18, wherein as the content of magnetic particles increases, an integral value of G″ increases for a section in which the value of shear strain applied to the magnetorheological fluid is in the range of 0.01% to 100%.

21. The method of claim 18, wherein as the intensity of the applied magnetic field increases, the integral value of G″ increases for the section in which the value of shear strain applied to the magnetorheological fluid is in the range of 0.01% to 100%.

22. The method of claim 18, wherein the applied magnetic field intensity and the bump area have a linear relationship y = ax + b [x represents the magnetic field intensity, y represents the bump area], and a = 73.1 ± 2.0.
